(19) United States
(12) Patent Application Publication
(10) Pub. No.: US 2014/0139558 A1
(43) Pub. Date: May 22, 2014

(54) Driving controller, display panel device, and driving method capable of reducing crosstalk

(71) Applicant: InnoLux Corporation, Miao-Li County (TW)

(72) Inventors: Ming-Tsung TSENG, Miao-Li County (TW); Kun-Hsien YANG, Miao-Li County (TW); Yung-Yi CHIU, Miao-Li County (TW); Cha YU, Miao-Li County (TW)

(73) Assignee: InnoLux Corporation, Miao-Li County (TW)

(21) Appl. No.: 14/062,996

(22) Filed: Oct. 25, 2013

(30) Foreign Application Priority Data
Nov. 21, 2012 (TW) 101143397

(51) Int. Cl. G09G 3/36; G09G 3/20

(52) U.S. Cl. CPC G09G 3/3655; G09G 3/3614; G09G 3/2003
USPC 345/690; 345/209

(57) ABSTRACT

A driving controller for reducing crosstalk in a display panel device includes a type detection unit and a polarity configuration unit. The type detection unit receives a color domain signal corresponding to one line data of an image so as to decide a data type of the line data. The polarity configuration unit is connected to the type detection unit for producing a polarity configuration corresponding to the data type of the line data based on the data type.

### BACKGROUND OF THE INVENTION

1. Field of the Invention

The present invention relates to the technical field of display panels and, more particularly, to a driving controller, a display panel device, and a driving method capable of reducing crosstalk.

2. Description of Related Art

Generally, crosstalk refers to a phenomenon that the screen of a certain area of LCD may influence the brightness of its adjacent area, which is very common in LCD. The crosstalk phenomenon is easily observed when the background is of certain gray levels. A typical cross test screen is provided to draw a pattern with blocks in black and white check for test in a state of 128 gray levels. Theoretically, the periphery of the pattern blocks in black and white check should be maintained with 128 gray levels. If there is a brightness change on the 128 gray levels of the peripheral area of the pattern blocks in black and white check, the crosstalk phenomenon is present.

In LCD, the capacitance coupling effect between data line and common electrode (Vcom) is one of the reasons that causes the crosstalk phenomenon. For the capacitance coupling effect between data line and common electrode, a direct solution is to rearrange the layout of the data lines so as to reduce the capacitance coupling effect.

When being displayed with the same gray level, multiple display lines in LCD need to reference to the same reference voltage. If the buffer of reference voltage does not have sufficient driving power, the setting of the output voltage of the display line becomes incorrect which thus influences the data line corresponding to the reference voltage, resulting in crosstalk phenomenon. To solve this problem, the prior method is to increase the driving power of the buffer of reference voltage. However, even though the layout of data lines is rearranged or the driving power of the buffer of reference voltage is increased, the crosstalk phenomenon is still existed. Therefore, it is desired to have an improved driving controller, display panel device, and driving method to mitigate and/or obviate the aforementioned problems.

### SUMMARY OF THE INVENTION

The object of the present invention is to provide a driving controller, a display panel device, and a driving method capable of effectively reducing crosstalk phenomenon.

In accordance with one aspect of the present invention, there is provided a driving controller capable of reducing crosstalk, which comprises a type detection unit and a polarity configuration unit. The type detection unit is provided for receiving a color domain signal corresponding to any one line data of an image data, and determining a data type of the line data. The polarity configuration unit is connected to the type detection unit for generating a polarity configuration corresponding to the data type of the line data.

In accordance with another aspect of the present invention, there is provided a driving controller for driving an LCD panel having a plurality of gate driving lines, The driving controller comprises: a type detection unit for receiving a color domain signal corresponding to any one line data of an image data, and determining a data type of the line data; and a polarity configuration unit connected to the type detection unit for generating a polarity configuration corresponding to the data type of the line data, such that each of the gate driving lines has different data polarity configuration.

In accordance with still another aspect of the present invention, there is provided a display panel device driving method capable of reducing crosstalk, which comprises: receiving an image data and converting any one line data of the image data into a color domain signal; determining a data pattern of the line data based on the color domain signal; generating a polarity configuration corresponding to the data pattern of the line data based on the data pattern; and generating a corresponding control signal to a source driver based on the polarity configuration.

In accordance with a further aspect of the present invention, there is provided a display panel device, which comprises an LCD panel, a gate driver, a source driver, and a driving controller. The gate driver is connected to the LCD panel for generating a display scanning signal so as to drive the LCD panel. The source driver has a plurality driving channels connected to the LCD panel. The driving controller is connected to the source driver for receiving an image data and providing the source driver to output display signal based on the image data, wherein the driving controller comprises: a type detection unit and a polarity configuration unit. The type detection unit is provided for receiving a color domain signal corresponding to any one line data of the image data, and determining a data type of the line data. The polarity configuration unit is connected to the type detection unit for generating a polarity configuration corresponding to the data type of the line data based on the data type. In one feature of the present invention, the plurality of driving channels of the source driver are performed with optimized polarity configuration according to the data type of any line data. In another feature of the present invention, the polarity configuration of the source driver can be achieved according to a polarity update unit of a (open) panel configuration.

Other objects, advantages, and novel features of the invention will become more apparent from the following detailed description when taken in conjunction with the accompanying drawings.

### BRIEF DESCRIPTION OF THE DRAWINGS

FIG. 1 shows a block diagram of the driving controller capable of reducing crosstalk in accordance with the present invention;

FIG. 2 illustrates the pseudo code with which the type detection unit determines the pattern of 1B1W;

FIG. 3 schematically illustrates a display panel device using the driving controller capable of reducing crosstalk in accordance with the present invention;

FIG. 4 schematically illustrates the polarity configuration of the prior source driver in a normal mode;

FIG. 5 schematically illustrates the polarity configuration of the prior source driver in a square inversion mode;

FIG. 6 schematically illustrates sub-pixel in the gate line;

FIG. 7(A) schematically illustrates the polarity configuration of the prior source driver in a column inversion mode at the pattern of 1B1W;

FIG. 7(B) is the waveform of FIG. 7(A);

FIG. 8(A) schematically illustrates the polarity configuration of the prior source driver in a square inversion mode at the pattern of 1B1W;

FIG. 8(B) is the waveform of FIG. 8(A);

FIG. 9(A) schematically illustrates the polarity configuration of the prior source driver in a column inversion mode at the pattern of 2B2W;

FIG. 9(B) is the waveform of FIG. 9(A);

FIG. 10(A) schematically illustrates the polarity configuration of the inventive source driver in a square inversion mode at the pattern of 2B2W;

FIG. 10(B) is the waveform of FIG. 10(A);

FIG. 11(A) schematically illustrates the polarity configuration of the prior source driver in a column inversion mode at the pattern of 4B4W;

FIG. 11(B) is the waveform of FIG. 11(A);

FIG. 12(A) schematically illustrates the polarity configuration of the prior source driver in a square inversion mode at the pattern of 4B4W;

FIG. 12(B) is the waveform of FIG. 12(A); and

FIG. 13 is a flowchart for the driving method capable of reducing crosstalk in accordance with the present invention.

### DETAILED DESCRIPTION OF THE PREFERRED EMBODIMENT

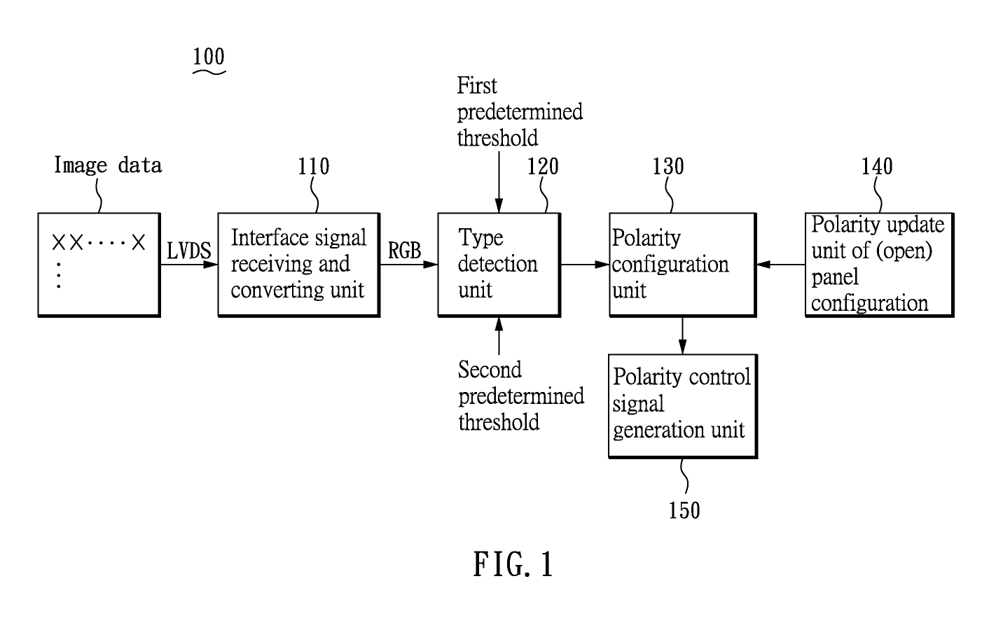

With reference to FIG. 1, there is shown a block diagram of the driving controller 100 capable of reducing crosstalk in accordance with the present invention. The driving controller 100 capable of reducing crosstalk includes an interface signal receiving and converting unit 110, a type detection unit 120, a polarity configuration unit 130, a polarity update unit 140 of a (open) panel configuration, and a polarity control signal generation unit 150.

The interface signal receiving and converting unit 110 receives an image data and converts any one line data of the image data into a color domain signal.

The line data received by the interface signal receiving and converting unit 110 is an LVDS (low-voltage differential signaling) signal. The color domain signal is of (R, G, B) format. That is, the interface signal receiving and converting unit 110 converts the received LVDS signal into a corresponding pixel (color domain signal), and the pixel is of (R, G, B) format.

The type detection unit 120 receives the color domain signal corresponding to the line data, and determines the data type of the line data.

The type detection unit 120 is based on a first predetermined threshold (L1) and a second predetermined threshold (L2) to determine the data type of the line data. When the (R, G, B) format has 8 bits, the first predetermined threshold L1 is, for example, 200 and the second predetermined threshold L2 is, for example, 50. The first predetermined threshold L1 and the second predetermined threshold L2 can be pre-stored in the type detection unit 120 or can be dynamically updated from outside.

When the R, G and B values of the color domain signal are all larger than the first predetermined threshold L1, it is determined that the pixel (color domain signal) is white. When the R, G and B values of the color domain signal are all smaller than the second predetermined threshold L2, it is determined that the pixel (color domain signal) is black. When the R, G and B values of the color domain signal are larger than the second predetermined threshold L2 and smaller than the first predetermined threshold L1, there is no determination to be made.

The type detection unit 120 is based on the pixel value (color domain signal) of the line data to determine whether the pattern of the line data is one-black-one-white (1B1W), two-black-two-white (2B2W), three-black-three-white (3B3W), four-black-four-white (4B4W), eight-black-eight-white (8B8W), or n-black-m-white (nBmW), where n, m are each a natural number. The above determination is based on performing logic-AND on R, G and B. However, it is also applicable to use logic-OR determination as thresholds, so as to provide more versatile color patterns.

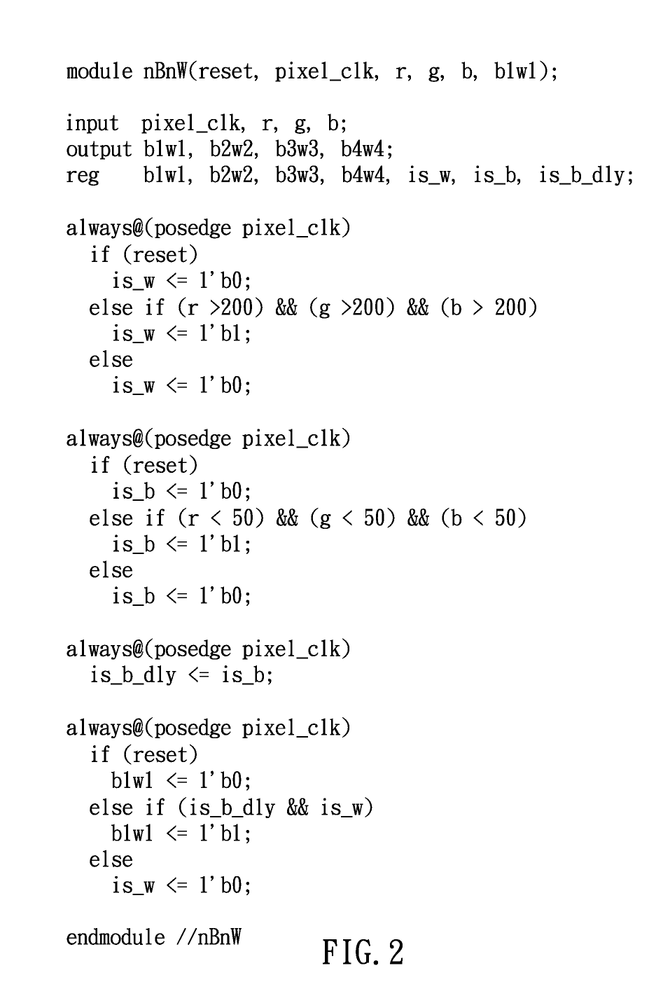

FIG. 2 illustrates the pseudo code with which the type detection unit 120 determines the pattern of 1B1W. Based on the disclosure of the present invention, those skilled in the art can infer the determination of other patterns and thus a detailed description therefor is deemed unnecessary.

The polarity configuration unit 130 is connected to the type detection unit and is based on the data type to generate a polarity configuration corresponding to the data type of the line data, wherein the polarity configuration unit 130 uses a look up table (LUT) to generate the polarity configuration corresponding to the data type of the line data. However, in other embodiments, the polarity configuration unit 130 is not restricted to use the LUT method.

The polarity update unit 140 of panel configuration is connected to the polarity configuration unit 130. The polarity configuration unit 130 is based on the panel display architecture of the polarity update unit 140 of panel configuration to perform polarity analysis and configuration.

The polarity control signal generation unit 150 is connected to the polarity configuration unit 130, and is based on the polarity configuration to generate a corresponding control signal to the source driver. The control signal can be POL1 and POL0. In other embodiments, the control signal is not restricted to be POL1 and POL0. Table 1 shows the corresponding relation between the control signal POL1 and POL0 and the driving channel of the source driver.

TABLE 1

| POL1 | POL0 | SD: SQINV-type |
|---|---|---|
| 0 | 0 | +−+− SQINV1 |
| 0 | 1 | +−−+ SQINV2 |
| 1 | 0 | −+−+ SQINV3 |
| 1 | 1 | −++− SQINV4 |

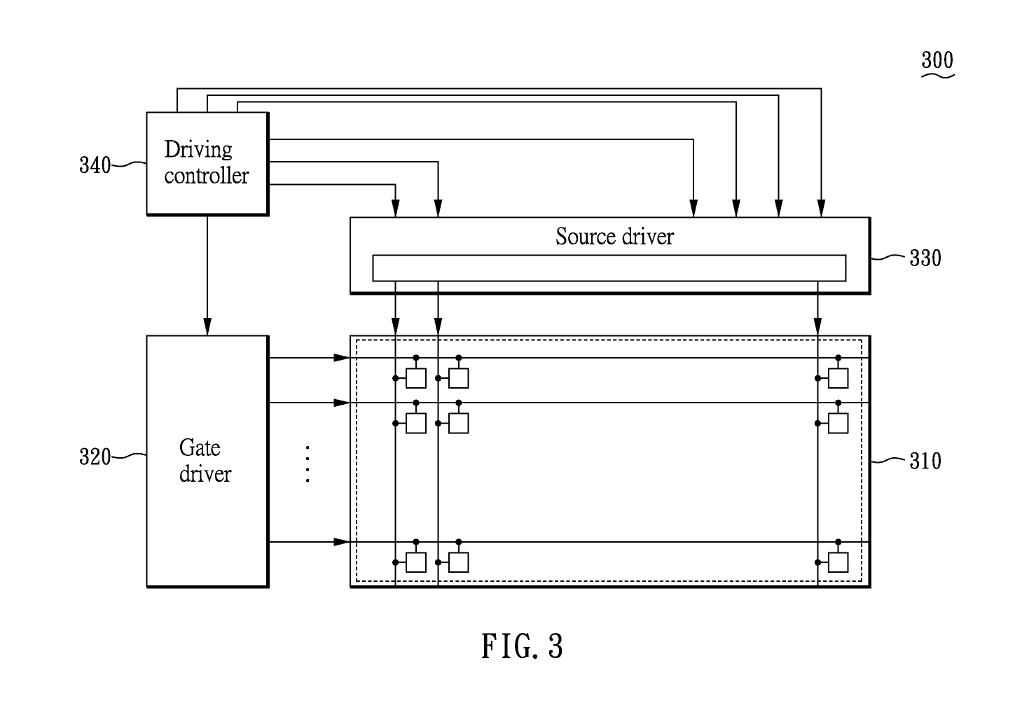

FIG. 3 schematically illustrates a display panel device 300 using the driving controller 100 capable of reducing crosstalk in accordance with the present invention. The display panel device 300 includes an LCD panel 310, a gate driver 320, a source driver 330, and a driving controller 340.

The gate driver 320 is connected to the LCD panel 310 having a plurality of gate driving lines for generating a display scanning signal so as to drive the LCD panel 310.

The source driver 330 has a plurality driving channels connected to the LCD panel 310 for driving the LCD panel 310 through a plurality of source lines electrically connected to the LCD panel 310 based on a display pixel signal.

The driving controller 340 is connected to the source driver 330 and the gate driver 320. The driving controller 340 receives an image data and, based on the image data, provides the timing of the display driving signal to the source driver 330 and the gate driver 329, wherein the plurality of driving channels of the source driver 330 are based on any one line data of the image data to perform polarity change.

The driving controller 340 is the same as that shown in FIG. 1 and described above, and thus a detailed description therefor is deemed unnecessary. The source driver 330 is based on the polarity control signal POL1 and POL0 to generate a polarity driving signal capable of reducing crosstalk.

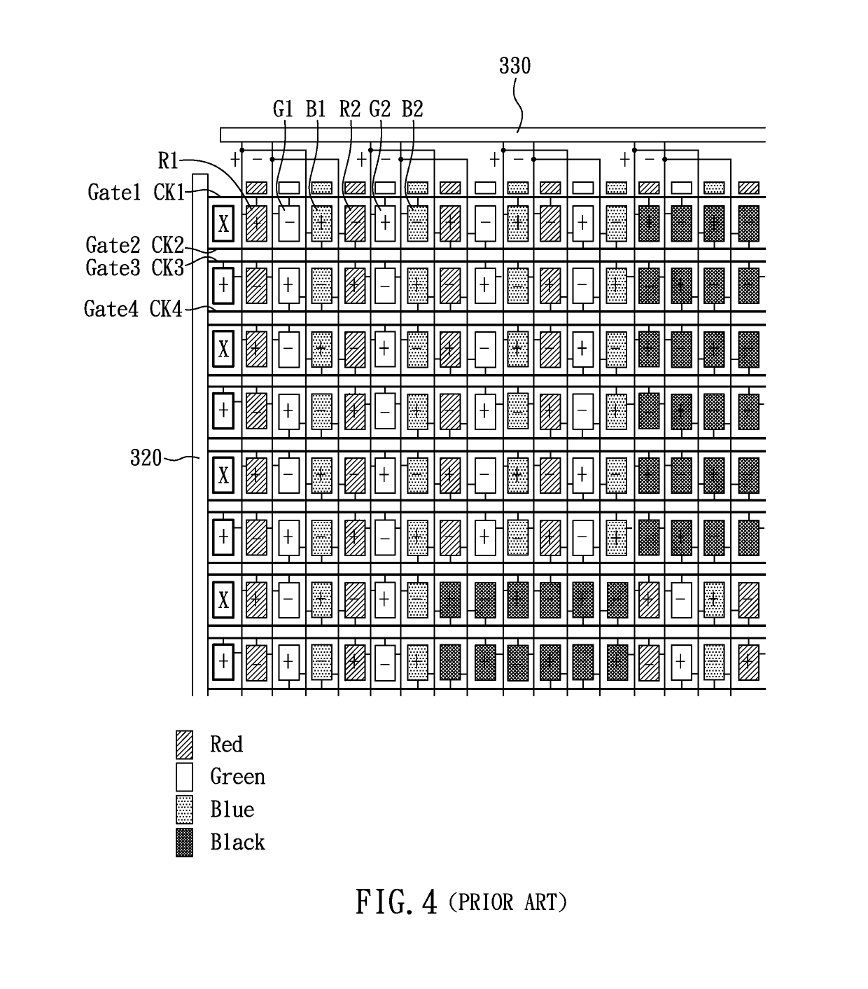

FIG. 4 schematically illustrates the polarity configuration of the prior source driver in a normal mode. As shown, in the normal mode, the polarity configuration of the source driver is: +−+−, +−+−, . . . , and such a polarity configuration is also known as a column inversion. FIG. 4 shown that the sub-pixels on one horizontal display line are controlled by two gate driving lines. For example, the sub-pixels on the first horizontal display line are controlled by the gate driving lines Gate CK1 and Gate CK2, and the sub-pixels on the second horizontal display line are controlled by the gate driving lines Gate CK3 and Gate CK4.

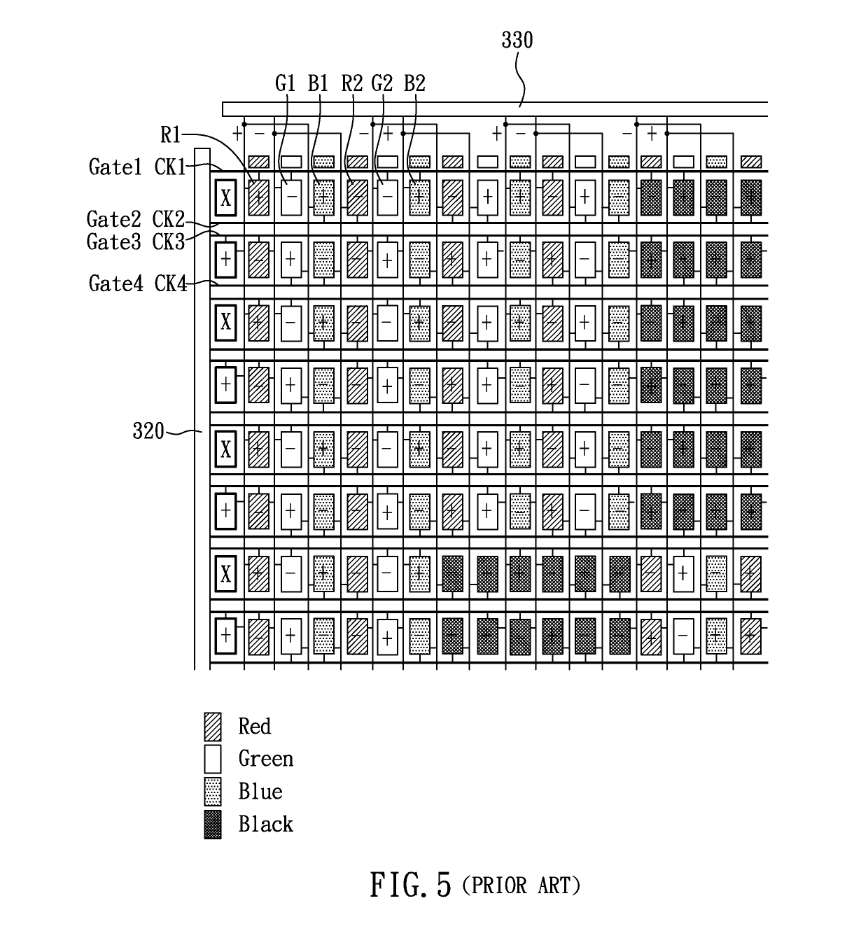

FIG. 5 schematically illustrates the polarity configuration of the prior source driver in a square inversion mode. As shown, the polarity configuration of the source driver is: +−−+, +−−+, . . . in the square inversion mode.

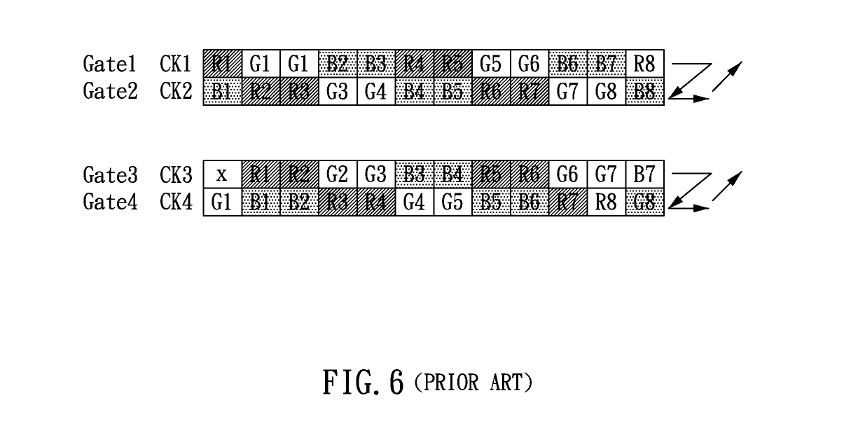

The polarity configurations in FIG. 4 and FIG. 5 are closely related to the layout wiring of the sub-pixels on a panel, which changes the polarity of the driving channel of the source driver. Based on the gate driving lines Gate CK1, Gate CK2, Gate CK3 and Gate CK4 in FIG. 4 and FIG. 5, the sub-pixels on the first and second horizontal display lines are re-arranged as shown in FIG. 6. FIG. 6 schematically illustrates sub-pixel display control. As shown, when the gate driving line Gate CK1 is turned on, the corresponding sub-pixels R1, G1, G2, B2, . . . are loaded with corresponding polarity voltages from the driving channels of the source driver. When the gate driving line Gate CK2 is turned on, the corresponding sub-pixels B1, R2, R3, G3, . . . are loaded with corresponding polarity voltages from the driving channels of the source driver. Therefore, FIG. 6 should be referenced for analyzing the polarity configuration of the driving channels of the source driver.

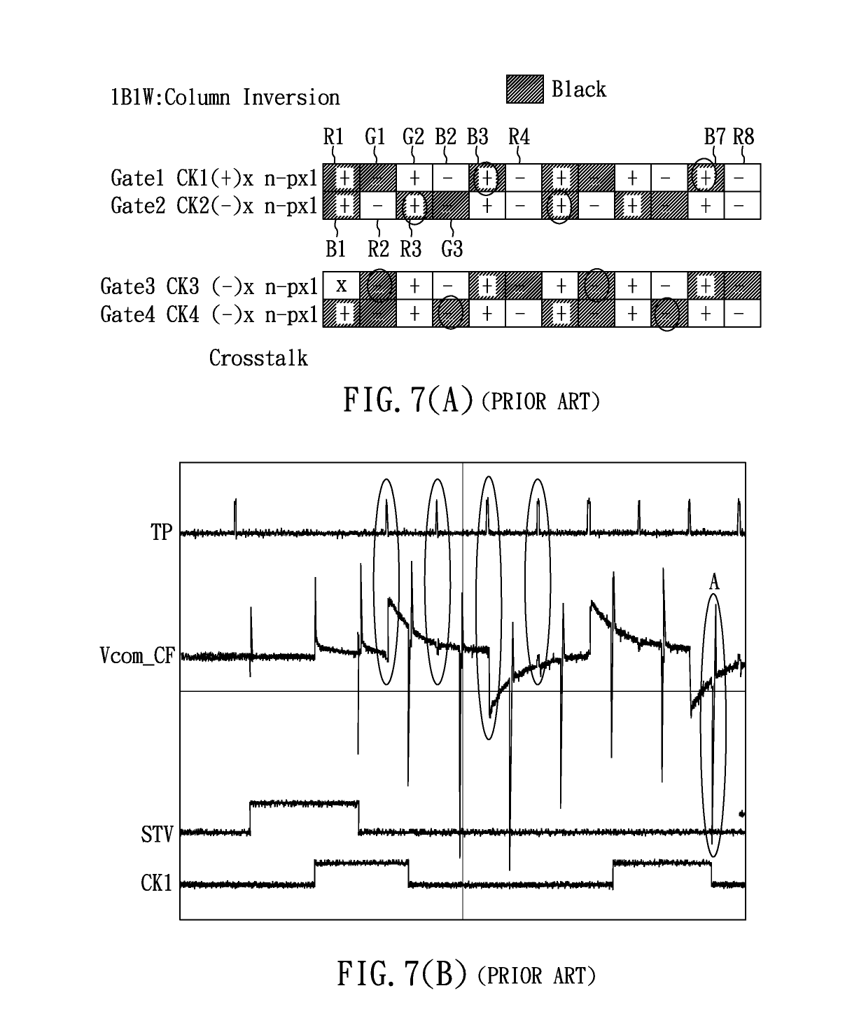

FIG. 7(A) schematically illustrates the polarity configuration of the prior source driver in a column inversion mode, which is the polarity configuration in the pattern of one-black-one-white (1B1W). As shown, because the pattern is one-black-one-white (1B1W), pixel 1 (R1, G1, B1) is black (1B) and its corresponding sub-pixels are also black, i.e., the sub-pixels R1, G1 and B1 are black; pixel 2 (R2, G2, B2) is white (1W) and its corresponding sub-pixels are also white, i.e., the sub-pixels R2, G2 and B2 are white.

FIG. 7(B) is the waveform of FIG. 7(A). As shown, signal STV transiting from low voltage to high voltage indicates that one frame is started to be displayed, and signal TP transiting from high voltage to low voltage indicates that corresponding voltage polarities are loaded from the driving channels of the source driver 330. As shown in FIG. 7(B), when signal TP transits to low voltage from high voltage, a relatively large disturbance can be measured on Vcom_CF, indicating that there is a large crosstalk on the display panel. Therefore, it can be observed that, when the polarity configuration on one horizontal data line is not balanced, the common electrode voltage Vcom is disturbed, resulting in the crosstalk. Furthermore, from FIG. 7(A), it is found that, when the polarity of horizontal data on one gate is not balanced, with the definition of having (+) and (−) in one set being balanced, a single (+) with larger weight is multiplied with N horizontal data pixels will cause the common electrode voltage (Vcom) to disturb toward positive voltage. The following embodiments have the same concept. By the way, it is noted that the crosstalk indicated by an oval A in FIG. 7(B) is caused by gate switching signal, which is not related to the aforementioned crosstalk generated by the common electrode.

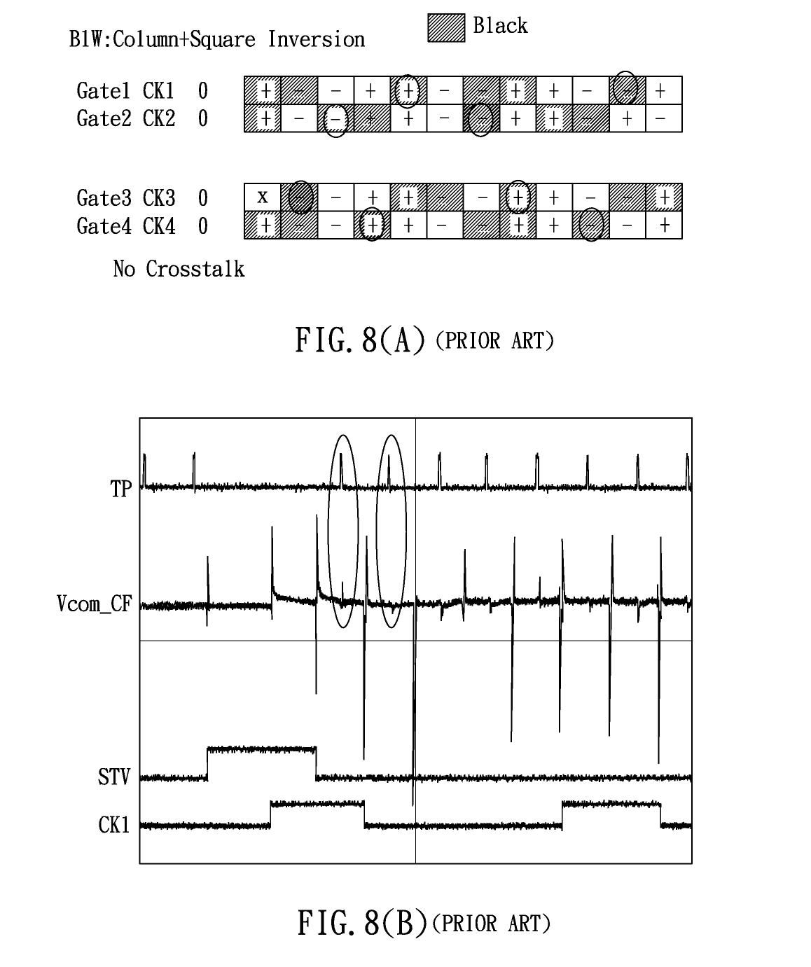

FIG. 8(A) schematically illustrates the polarity configuration of the prior source driver in a square inversion mode, which is the polarity configuration in the pattern of one-black-one-white (1B1W). As shown, because the pattern is one-black-one-white (1B1W), pixel 1 (R1, G1, B1) is black (1B) and its corresponding sub-pixels are also black, i.e., the sub-pixels R1, G1 and B1 are black; pixel 2 (R2, G2, B2) is white (1W) and its corresponding sub-pixels are also white, i.e., the sub-pixels R2, G2 and B2 are white.

FIG. 8(B) is the waveform of FIG. 8(A). As shown, signal TP transits from high voltage to low voltage when the driving channel of the source driver 330 is in the square inversion mode, and the disturbance measured on Vcom_CF is smaller than that in FIG. 7(B), indicating that the crosstalk on the display panel is small. Therefore, it can be observed that, when the polarity configuration on one horizontal data line is balanced, the common electrode voltage (Vcom) is not disturbed and thus no crosstalk is generated.

From the above description, it is found that the common electrode voltage (Vcom) is disturbed when the polarity of horizontal data is not balanced. Therefore, the present invention is proposed to optimize the polarity configuration for horizontal data in combination with using the driving controller to dynamically detect the data type on each horizontal data line thereby adjusting the polarity optimization (normal and square inversion by line switching).

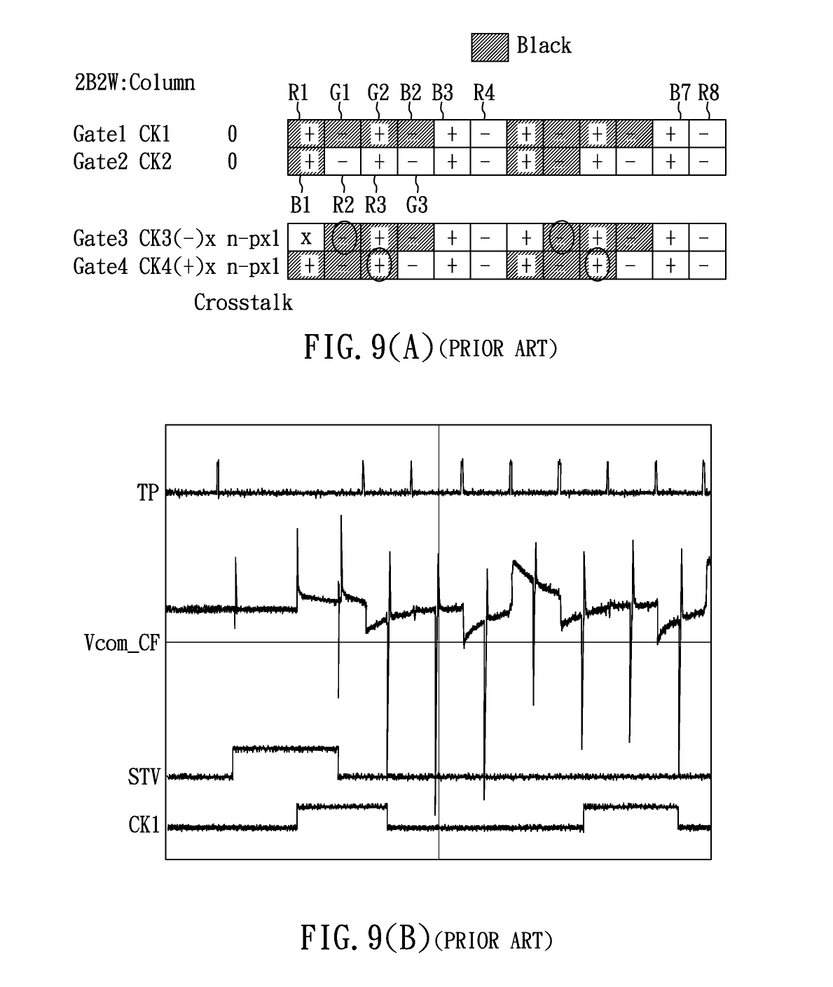

FIG. 9(A) schematically illustrates the polarity configuration of the prior source driver in a column inversion mode, which is the polarity configuration in the pattern of two-black-two-white (2B2W). As shown, because the pattern is two-black-two-white (2B2W), pixel 1 (R1, G1, B1) and pixel 2 (R2, G2, B2) are black (2B) and their corresponding sub-pixels are also black, i.e., the sub-pixels R1, G1, B1, R2, G2 and B2 are black; pixel 3 (R3, G3, B3) and pixel 4 (R4, G4, B4) are white (2W) and their corresponding sub-pixels are also white, i.e., the sub-pixels R3, G3, B3, R4, G4 and B4 are white.

FIG. 9(B) is the waveform of FIG. 9(A). As shown, when signal TP transits to low voltage from high voltage, a relatively large disturbance can be measured on Vcom_CF.

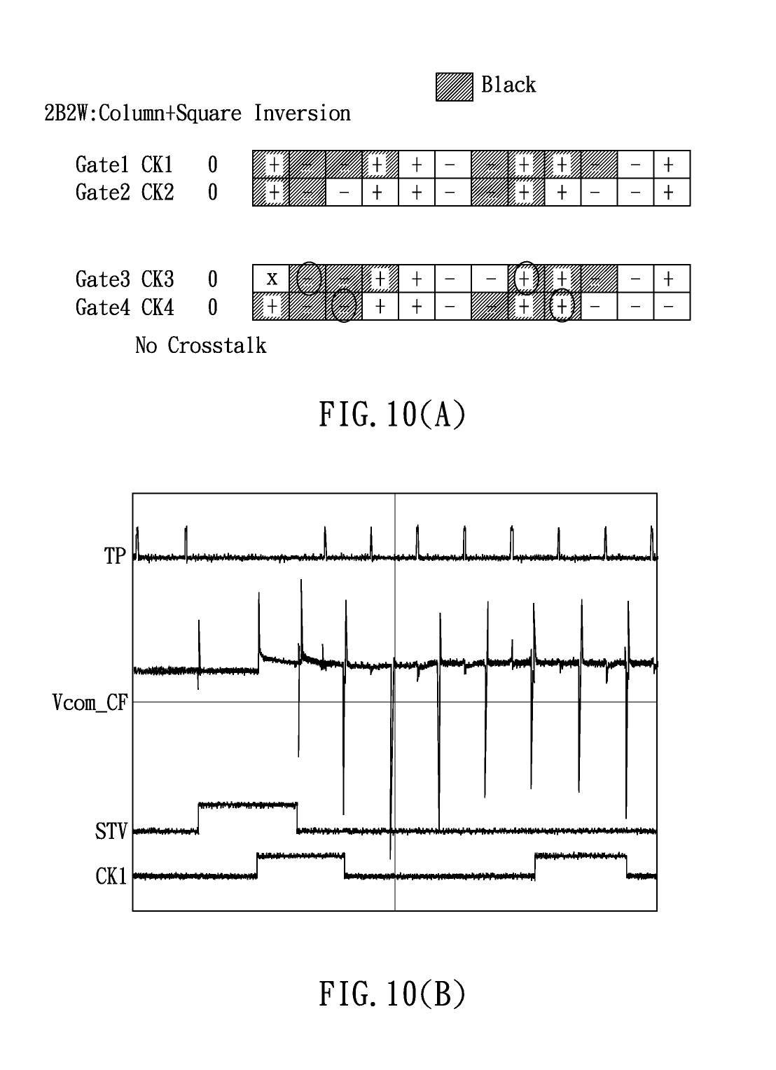

FIG. 10(A) schematically illustrates the polarity configuration of the inventive source driver in a square inversion mode, which is the polarity configuration in the pattern of two-black-two-white (2B2W). FIG. 10(B) is the waveform of FIG. 10(A). As shown in FIG. 10(B), when the driving channel of the source driver 330 is in the square inversion mode, signal TP transits to low voltage from high voltage and the disturbance measured on Vcom_CF is smaller than that in FIG. 9(B). The same phenomenon is applied to other patterns and thus a detailed description therefor is deemed unnecessary.

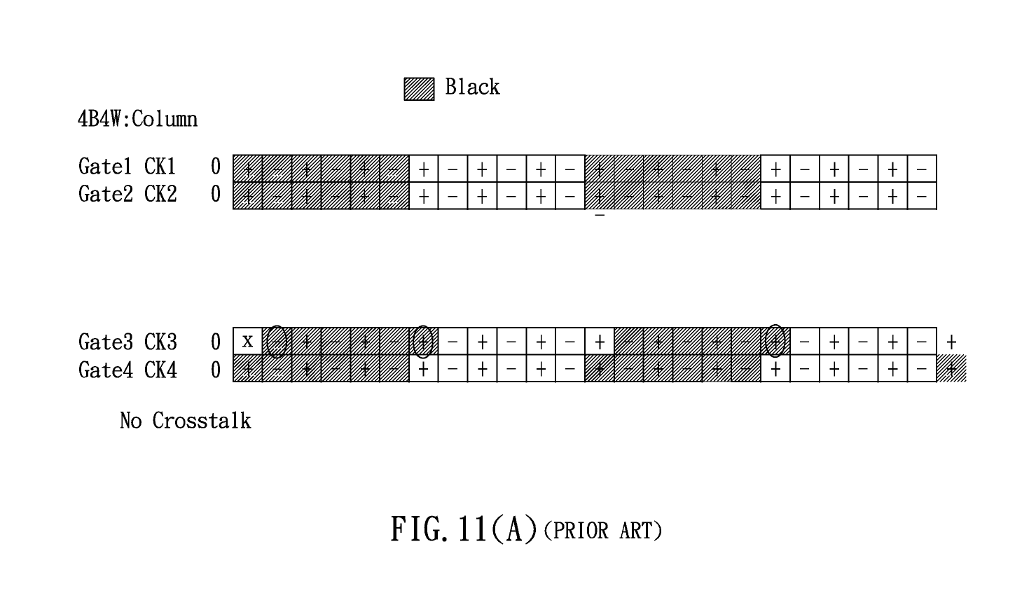

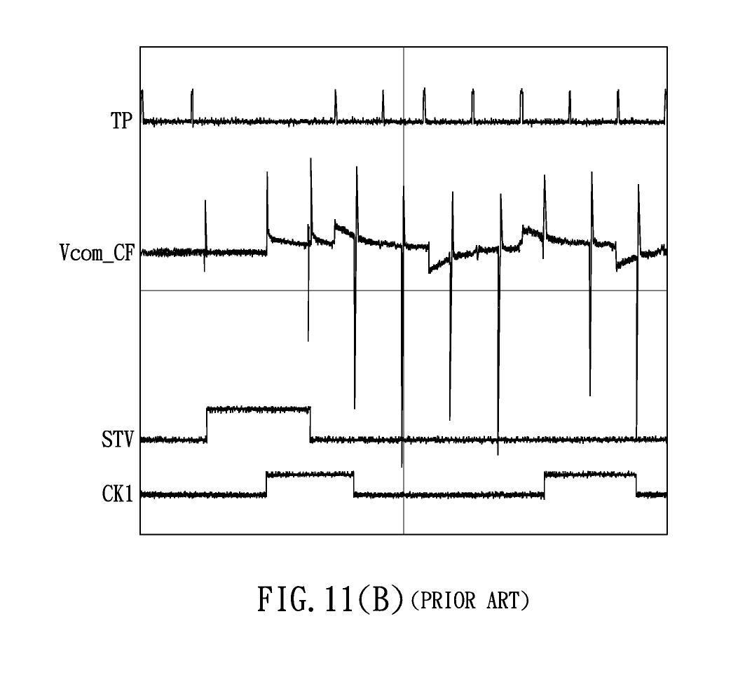

However, FIG. 11(A) schematically illustrates the polarity configuration of the prior source driver in a column inversion mode, which is the polarity configuration in the pattern of four-black-four-white (4B4W). FIG. 11(B) is the waveform of FIG. 11(A). As shown in FIG. 11(B), when signal TP transits to low voltage from high voltage, a relative small disturbance can be measured on Vcom_CF, and the crosstalk problem on the display panel is insignificant.

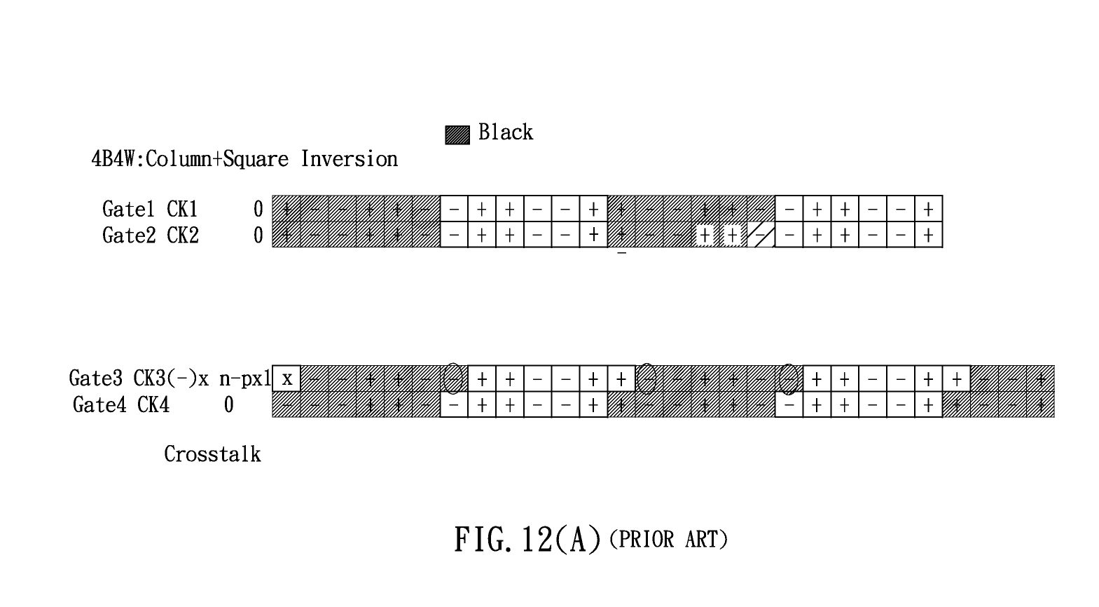

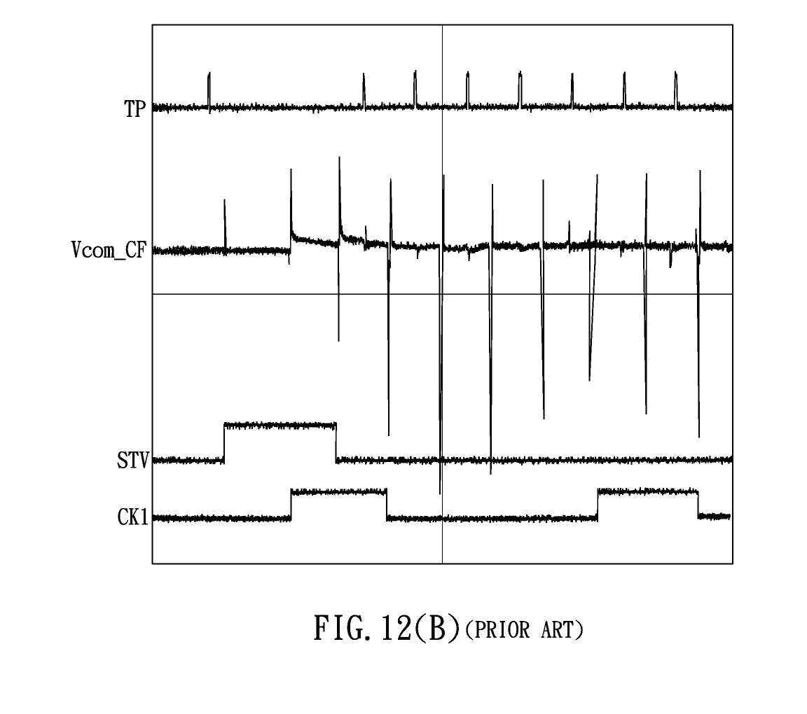

FIG. 12(A) schematically illustrates the polarity configuration of the prior source driver in a square inversion mode, which is the polarity configuration in the pattern of four-black-four-white (4B4W). FIG. 12(B) is the waveform of FIG. 12(A). As shown in FIG. 12(B), when the driving channel of the source driver 330 is in the square inversion mode and signal TP transits to low voltage from high voltage, the disturbance measured on Vcom_CF is bigger than that in FIG. 11(B), and the crosstalk problem on the display panel is significant.

Therefore, as different display screens require different preferable polarity configurations, the determination of polarity configuration should not be based only one the data of a frame. Instead, each line data has to be analyzed so as to effectively improve the crosstalk of a panel. The present invention performs analysis on the data of each line for accurately determining the polarity configuration, so as to effectively improve the crosstalk of a panel. The above method is proved by writing algorithm in lab to greatly reduce the color shift problem caused by crosstalk and unbalance of common electrode.

Moreover, the aforementioned description explains that the driving polarity mode of the source driver 330 is closely related to the crosstalk degree as the layout of sub-pixels is shown in FIG. 4 or FIG. 5 and in the pattern of n-black-m-white (nBmW). In 1B1W, the square inversion mode has smaller crosstalk and, in 4B4W, the column inversion mode has smaller crosstalk. However, in other sub-pixel layouts, the better inversion mode for the driving channel of the source driver 330 differs due to the difference of the layout and wiring. Therefore, the polarity update unit 140 of panel configuration in accordance with the present invention can optimize the polarity configuration for the source driver 330 by depending on the sub-pixel layout of the LCD panel 310 and using the data type based on the line data. That is, the polarity update unit 140 of panel configuration optimizes the polarity configuration for the source driver 330 by updating the look up table (LUT) of the polarity configuration unit 130. In addition, the polarity configuration unit 130 may generate a polarity configuration corresponding to the data type of the line data, such that each of the gate driving lines of the LCD panel 310 has different data polarity configuration, which is particularly applicable for a specific display screen in which the data type of any one line data is different each other, so as to reduce the crosstalk.

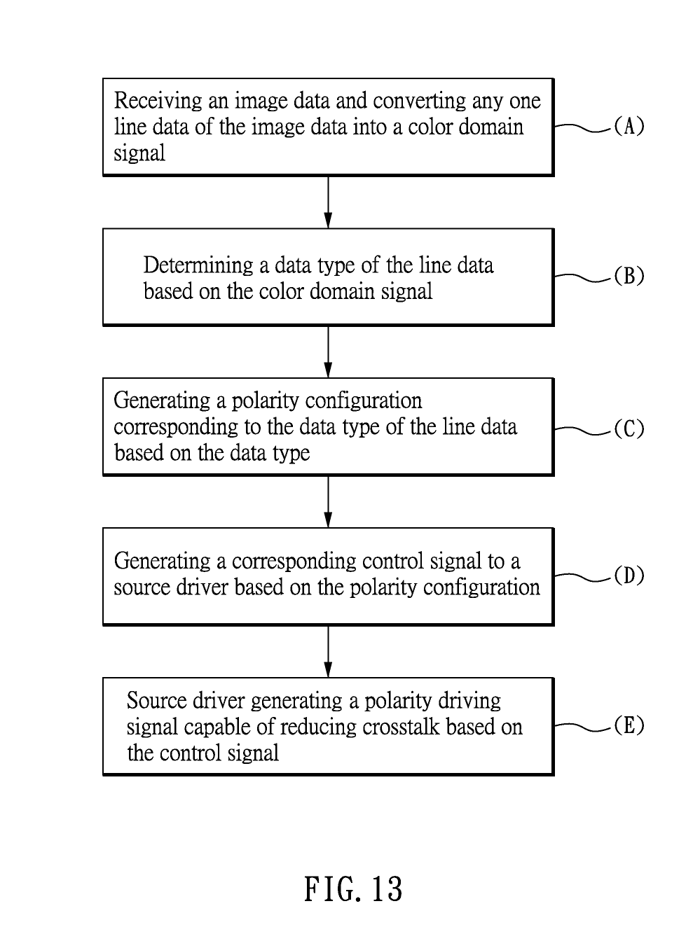

FIG. 13 is a flowchart for the driving method capable of reducing crosstalk in accordance with the present invention. First, in step (A), an image data is received, and any one line data of the image data is converted into a color domain signal. The line data is horizontal data of the image, and the color domain signal is of (R, G, B) format. That is, step (A) converts the received LVDS signal into a corresponding pixel (color domain signal), and the pixel is of (R, G, B) format.

In step (B), the color domain signal is used to determine the data type of the line data.

Step (B) is based on a first predetermined threshold and a second predetermined threshold to determine the data type of the line data. When the (R, G, B) format is of 8 bits, the first predetermined threshold is L1(200) and the second predetermined threshold is L2(50).

When the R, G and B values of the color domain signal are all larger than the first predetermined threshold, it is determined that the pixel (color domain signal) is white. When the R, G and B values of the color domain signal are all smaller than the second predetermined threshold, it is determined that the pixel (color domain signal) is black.

Based on the pixel value (color domain signal) of the line data, step (B) is able to determine whether the pattern of the line data is one-black-one-white (1B1W), two-black-two-white (2B2W), three-black-three-white (3B3W), four-black-four-white (4B4W), eight-black-eight-white (8B8W), or n-black-m-white (nBmW), where n, m are each a natural number.

In step (C), the data type is used to generate a polarity configuration corresponding to the data type of the line data, wherein step (C) uses a look up table (LUT) to generate the polarity configuration corresponding to the data type of the line data.

Step (D) is based on the polarity configuration to generate corresponding control signal (POL1, POL0) to a source driver.

In step (E), the source driver is based on the control signal to generate the polarity driving signal capable of reducing crosstalk.

In view of the foregoing, it is known that, when the sub-pixel layout of the LCD panel 310 is as shown in FIG. 4 or FIG. 5, and the first line data of an image data has one-black-one-white pattern and the second line data of an image data has four-black-four-white pattern, the polarity control signal generating unit 150 generates a control signal POL1 and POL0 of being 01 to the first line data. The polarity configuration of the driving channels of the source driver 330 is +−−+, +−−+, . . . to the first line data. The polarity control signal generating unit 150 generates a control signal POL1 and POL0 of being 00 to the second line data. The polarity configuration of the driving channels of the source driver 330 is +−+−, +−+−, . . . to the second line data. Accordingly, the Vcom CF disturbance corresponding to each line can be reduced so as to improve the crosstalk. When the sub-pixel layout of the LCD panel 310 is neither as shown in FIG. 4 nor as shown in FIG. 5, the polarity update unit 140 of panel configuration updates the look up table (LUT) and, as described hereinbefore, enables each line to correspond to a respective better polarity configuration, thereby reducing the crosstalk.

That is, with the present invention, the plurality of driving channels of the source driver are made to have optimal polarity configuration based on one horizontal data of the image data, which is different from the prior art in which the polarity for the plurality of driving channels of the source driver is changed according to one frame of the image data. Therefore, the present invention is able to effectively reduce the crosstalk.

In prior LCD screen, the capacitance coupling effect between data line and common electrode (Vcom) is one of the reasons that generates the crosstalk. In the array of a panel, the parasitic capacitance is coupled and existed in each sub-pixel. When the weight of data polarity is not balanced, disturbance on the common electrode is resulted, which causes crosstalk. Therefore, the present invention performs the optimization processing to the data polarity configuration.

For the crosstalk problem on a display panel, the prior art adopts a closed pattern detection and use a frame-based scheme to perform polarity switching for the driving channels of the source driver. When there is a pattern of crosstalk, the polarity of the driving channels of the source driver is changed from +−+− to +−−+. However, the prior art suffers a drawback in that it is unable to perform corresponding polarity configuration based on the wiring distribution of the pattern on the panel architecture. Further, with the closed type detection, it is unable to flexibly and comprehensively optimize the polarity configuration on the panel architecture based on the pattern due to that, when the panel architecture is different or under the same screen, different lines have different patterns and the preferable polarity configuration is different. Thus, the closed detection of prior art cannot satisfy the comprehensive panel architecture and the comprehensive type detection. Based on the above reasons, the present invention adopts an open method and technique for reducing crosstalk and color shift based on the panel architecture capable of being filled with horizontal and vertical data polarity configuration.

The spirit of the present invention is based on that the common electrode is likely to be disturbed to generate crosstalk when the polarity of one image horizontal line data is not balanced. In order to prevent the common electrode from disturbance, each image horizontal line data is proceeded with optimized polarity configuration, and the vertical polarity balance is also considered to perform a normal and square inversion mode by line switching, thereby reducing the crosstalk and color shift.

Although the present invention has been explained in relation to its preferred embodiment, it is to be understood that many other possible modifications and variations can be made without departing from the spirit and scope of the invention as hereinafter claimed.

What is claimed is:

1. A driving controller, comprising:
a type detection unit for receiving a color domain signal corresponding to any one line data of an image data, and determining a data type of the line data; and
a polarity configuration unit connected to the type detection unit for generating a polarity configuration corresponding to the data type of the line data.

2. The driving controller as claimed in claim 1, further comprising:
an interface signal receiving and converting unit for receiving the image data and converting the line data of the image data into the color domain signal;
a polarity update unit of panel configuration connected to the polarity configuration unit for optimizing the polarity configuration of the data type based on the line data for a source driver; and
a polarity control signal generation unit connected to the polarity configuration unit for generating a corresponding control signal to the source driver based on the polarity configuration.

3. The driving controller as claimed in claim 1, wherein the type detection unit determines the data type of the line data based on a first predetermined threshold and a second predetermined threshold.

4. The driving controller as claimed in claim 3, wherein, when the color domain signal has a format of 8 bits, the first predetermined threshold is L1 and the second predetermined threshold is L2, so as to use L1 and L2 to determine the data type of the line data.

5. The driving controller as claimed in claim 1, wherein the polarity configuration unit uses a look up table to generate the corresponding polarity configuration based on the data type.

6. The driving controller as claimed in claim 2, wherein the polarity update unit of panel configuration updates the look up table.

7. A display device, comprising:
a plurality of gate driving lines;
wherein each of the gate driving lines has different data polarity configuration.

8. A display panel device, comprising:
an LCD panel;
a gate driver connected to the LCD panel for generating a display scanning signal so as to drive the LCD panel;
a source driver connected to the LCD panel; and
a driving controller connected to the source driver for receiving an image data, wherein the driving controller comprises:
a type detection unit for receiving a color domain signal corresponding to any one line data of the image data, and determining a data type of the line data; and
a polarity configuration unit connected to the type detection unit for generating a polarity configuration corresponding to the data type of the line data.

9. The display panel device as claimed in claim 8, wherein the driving controller further comprises:
an interface signal receiving and converting unit for receiving the image data and converting the line data of the image data into the color domain signal;
a polarity update unit of panel configuration connected to the polarity configuration unit for optimizing the polarity configuration of the data type based on the line data of the LCD panel for the source driver; and
a polarity control signal generation unit connected to the polarity configuration unit for generating a corresponding control signal to the source driver based on the polarity configuration.
